(19) United States
(12) Patent Application Publication
(10) Pub. No.: US 2018/0301713 A1
(43) Pub. Date: Oct. 18, 2018

(54) LOW-WEIGHT NEEDLED FABRIC, METHOD FOR THE PRODUCTION THEREOF AND USE OF SAME IN A DIFFUSION LAYER FOR A FUEL CELL

(71) Applicants: Hexcel Reinforcements, Dagneux (FR); Commissariat A L'Energie Atomique Et Aux Energies Alternatives, Paris (FR)

(72) Inventors: Julien Bardy, Veyrins-thuellin (FR); Jean-Marc Beraud, Rives (FR); Leo Merchat, Grenoble (FR); Maxime Schroder, Buironfosse (FR); Andrea Viard, Villemoirien (FR); Remi Vincent, Grenoble (FR)

(21) Appl. No.: 15/766,854

(22) PCT Filed: Oct. 14, 2016
(86) PCT No.: PCT/FR2016/052667

§ 371 Date: Apr. 9, 2018

(30) Foreign Application Priority Data
Oct. 16, 2015 (FR) 1559856

(51) Int. Cl. H01M 4/88; H01M 4/86; D03D 15/00; D03D 13/00

(52) U.S. Cl. CPC H01M 4/8807; H01M 4/8605; D10B 2101/12; D03D 13/008; D03D 15/00

(57) ABSTRACT

The invention relates to a fabric comprising carbon threads, said fabric having a mass per unit area within the range of 40 g/m² to 100 g/m², preferably from 40 g/m² to 80 g/m², specifically from 60 g/m² to 80 g/m², and characterized in that it comprises staple fibers, said staple fibers extending out from the threads constituting the fabric from which they originate and extending in a direction that is not parallel to the direction of the thread from which they originate and/or in that the fabric is needled. The invention also relates to the use of this fabric in a diffusion layer for a fuel cell and a method for manufacturing this diffusion layer.

### FIELD OF THE INVENTION

The present invention relates to the field of materials used in electrochemical systems or devices, such as fuel cells.

Specifically, the invention relates to a fabric, in particular lightweight needled fabric, its manufacturing method, and its use as a support in a diffusion layer.

### PRIOR ART

A PEMFC (Proton Exchange Membrane Fuel Cell) is a current generator whose operating principle is based on the conversion of chemical energy into electrical energy via catalytic reaction of a fuel (generally H₂) and a combustion agent (generally O₂). Therefore, this energy production occurs via electrochemical conversion.

A fuel cell includes at least one electrochemical cell, but more generally a stack of a series of several electrochemical cells in order to meet the needs of applications, connected to one or more current collectors. Each electrochemical cell includes a membrane electrode assembly (MEA) that performs the electrochemical conversion.

A membrane electrode assembly (MEA) is composed:
of a conductive membrane that forms an electrolyte,
of two active layers (or anode and cathode electrodes) where the electrochemical reactions take place; they are located on either side of the membrane;
of two bipolar plates;
of two gas diffusion layers (GDLs), each of which is located between an active layer and a bipolar plate.

In general, the conductive membrane has one or more proton or ionomer polymers, generally a Nafion®-type perfluorosulfonated polymer. It separates the anode from the cathode and does not allow electrons or gases to pass through. It conducts protons.

The electrodes are composed of a catalyst (generally platinum), carbon, and ionomer. They must allow the transport of protons toward the membrane, the transport of electrodes toward the current collectors via the diffusion layers and the bipolar plates, and the transport of reagents along with reaction products, water, and heat.

The bipolar plates ensure gas distribution along with the discharge of excess water and reagents by means of millimetric channels, while conducting electricity. They are generally made of nonporous graphite or of a carbon/polymer composite material.

The diffusion layers play several roles in a fuel cell. Specifically, they enable reagents (combustible gas and combustion agent) and, if applicable, water vapor to travel from the bipolar plate to the active layer; they enable the discharge of liquid water and vapor; the conduction of the current produced at the active layer to the bipolar plate; the discharge of the heat produced at the active layer, and they mechanically reinforce the membrane/active layers assembly.

To perform these various roles, a diffusion layer must have effective properties in terms of mass per unit area, thickness, electric conductivity, heat conductivity, air permeability, hydrophobicity, chemical stability, and physical stability. In particular, the diffusion layer must be sufficiently rigid to act as a mechanical reinforcement for the MEAs, due to the architecture of the bipolar plates' channels. They must also be sufficiently porous to gases in order to enable gas exchanges between the active layers and the polar plates, and sufficiently porous to water to allow it to be discharged toward the bipolar plates without preventing the humidification of the active layers in order to encourage proton transfer.

The diffusion layers generally comprise a support, in the form of a fabric, paper, or felt-type carbon fiber reinforcement that is subsequently made hydrophobic by chemical processing. This type of chemical processing is, e.g., disclosed in US Patent Application 2014/025581. In general, a microporous layer is also applied onto these supports. The microporous layer is composed of pores whose diameter is approximately one micron. These pores are smaller than those of the diffusion layer support. The microporous layer is the interface between the diffusion layer and the active layer. The addition of a microporous layer to the support of a diffusion layer improves the performance of the fuel cell by means of its activity in water management. This type of microporous layer is, e.g., disclosed in US Patent Application 2014/0205919.

Therefore, the design of a diffusion layer is complex because its performance depends upon optimization among the properties of the support, the hydrophobic processing, the microporous layer, and the processibility of all of these components. The processibility of the support relates to the ability of a support to travel along various coating lines (hence its ability to be unwound, to travel over various rollers, and to be rewound) without significant deformation. The processibility of the support is estimated based on its mechanical strength and its ability to be fully soaked, since this type of soaking is generally used during hydrophobic processing.

Various documents have addressed the structure of the support and how to improve it for use in a diffusion layer.

EP 1445811 discloses a carbon fiber woven support to be used as a diffusion layer. This support is made of warp threads and weft threads formed into a carbon fiber precursor; the threads have a mass per unit length within the range of 0.005 to 0.028 g/m. The density of the threads is 20 threads/cm. The mass per unit area of this fabric listed in this document ranges from 50 to 150 g/m². This support is obtained by a step that involves pressurizing, in the direction of thickness, a fabric made of carbon fiber precursor threads, followed by a step for carbonizing the fabric in order to obtain a carbon fiber fabric. The pressurizing step reduces the thickness of the support. This fabric is slightly deformable when compressed. The threads used for the manufacture of this woven support are very fine, hence expensive to produce, and fragile. These threads can break easily, which potentially impacts the speed at which the woven support can be produced, along with its processibility.

WO 2011/131737 discloses a support for a diffusion layer, the support being formed of a plurality of unidirectional sheets of carbon threads that are placed one atop the other and connected to each other by an interweaving of broken carbon threads, obtained via needling. The unidirectional sheets are placed one atop the other while alternating the orientation of each of the sheets. Needling is performed in a direction parallel to the thickness of the produced multiaxial sheet. When this support is used as a diffusion layer inside an electrochemical cell, it improves the letter's performance. For reinforcements of this type in which all of the fibers are oriented parallel to the thickness, a high number of needle impacts per cm² of support is necessary. Despite the high number of impacts applied onto the layering of unidirectional sheets, the obtained assembly is still difficult to process and, more often than not, it is necessary to perform post-processing in order to consolidate the assembly so that it can be handled or transported. The agents present in post-processing may diminish the performance of the diffusion layer.

Diffusion layers currently on the market are made of fabricated nonwoven or woven, paper-type carbon fiber textiles. At present, the best properties are achieved with paper and nonwoven supports.

However, the use of paper and nonwoven supports involves several disadvantages. In these supports, the carbon fibers are oriented in a disorganized fashion. This may result in non-optimal reproducibility of the features of the created diffusion support. Moreover, paper or nonwoven supports are difficult to handle, in particular when they weigh less than or equal to 100 g/m². In order to help their processibility, additives such as binders or stabilizers are added to these supports. These additives may pollute the diffusion layer and harm its performance. A depollution step is, in this case, often necessary so that the diffusion layer can be used, which increases the cost and complexity of its manufacturing method.

The use of needled carbon fiber weaves has been disclosed for applications as a reinforcement structure, e.g., for brake pads, in U.S. Pat. No. 4,790,052 and in WO 99/12733, which is therefore a technical field that is very distant from the invention in which the textiles used meet very different specifications than those for fuel cells.

Therefore, a need exists for providing a support for a diffusion layer that offers the advantage of good processibility while not affecting the performance of the diffusion layer, specifically in terms of current density.

In this context, the invention is intended to solve the above-mentioned problems by providing a novel support for a diffusion layer that offers good processibility and good performance in terms of current density, along with its manufacturing method.

This goal is achieved thanks to a needled fabric composed of carbon threads and having a mass per unit area within the range of 40 g/m² to 100 g/m².

### SUMMARY OF THE INVENTION

An initial aim of the invention relates to a fabric comprising carbon threads, said fabric having a mass per unit area within the range of 40 g/m² to 100 g/m², preferably within the range of 40 g/m² a 80 g/m², specifically within the range of 60 g/m² to 80 g/m², characterized in that it comprises staple fibers, said staple fibers extending out from the component threads of the fabric from which they originate and extending out in a direction that is not parallel to the thread from which they originate.

The fabric according to the invention simultaneously offers a good compromise among mass per unit area, thickness, permeability, porosity, electrical conductivity, physical stability, and chemical stability. It also offers the advantage of being easy to process without the addition of additives. Therefore, it is highly suitable for acting as a support in a fuel cell diffusion layer.

Another aim of the invention relates to the use of a fabric as defined in the framework of the invention for the manufacture of a diffusion layer, specifically for a fuel cell.

Yet another aim of the invention is a fuel cell diffusion layer, characterized in that it comprises at least one fabric according to the invention, said fabric comprising at least one hydrophobic coating. This type of diffusion layer may additionally include at least one microporous layer. This type of microporous layer will be deposited onto at least one portion of the coating that is present on the surface of the fabric according to the invention.

The invention also relates to a method for manufacturing a fabric according to the invention, characterized in that it includes at least the following steps:
having at least one fabric comprising carbon threads and a mass per unit area within the range of 40 g/m² to 100 g/m², preferably within the range of 40 g/m² to 80 g/m², specifically within the range of 60 g/m² to 80 g/m²;
needling said fabric starting from at least one of its broad sides; as well as a method for preparing diffusion layers according to the invention. A further aim of the invention is a fuel cell including at least one diffusion layer according to the invention.

The following detailed description, with reference to the attached Figures, will allow the invention to be more fully understood.

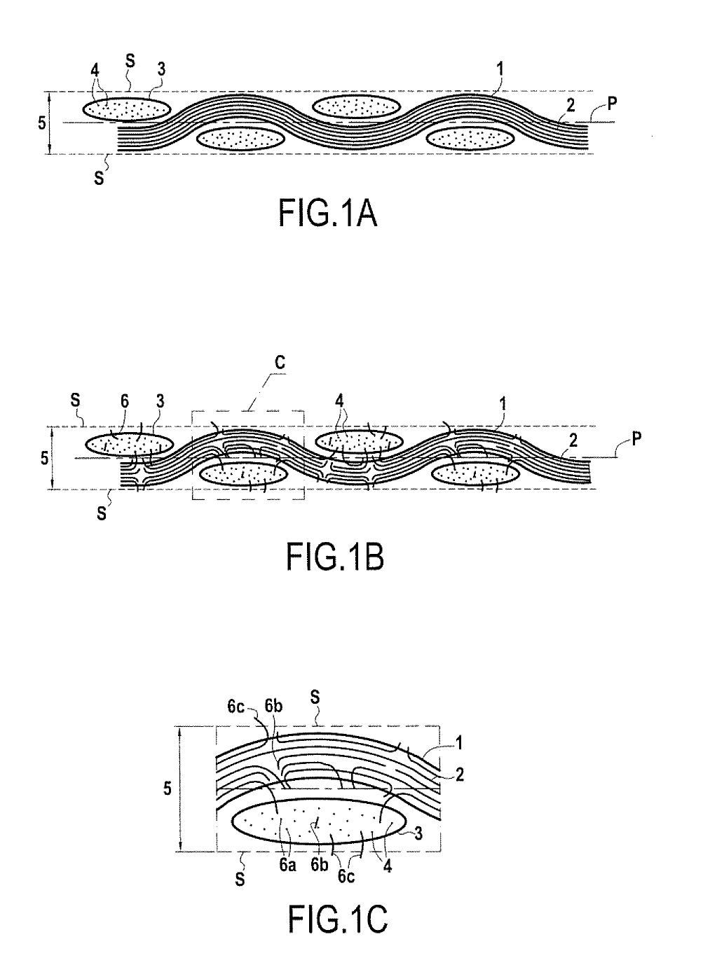

FIG. 1A is a schematic representation of a cross-section of a fabric that can be used in the framework of the invention, before any needling has been performed.

FIG. 1B is a schematic representation of a cross-section of a fabric in accordance with the invention, corresponding to the fabric in FIG. 1A, after needling.

FIG. 1C is an enlargement of a portion of FIG. 1B showing a warp thread and a weft thread.

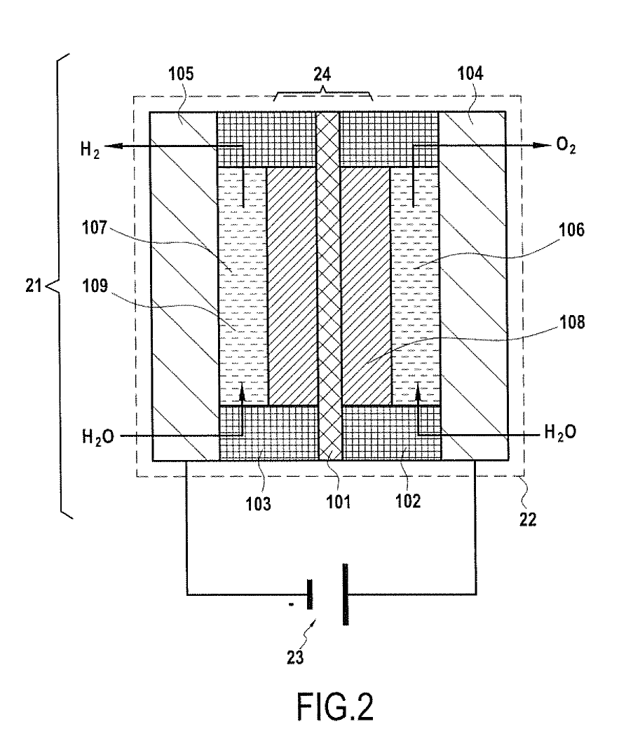

FIG. 2 is a sectional schematic representation of a GDL.

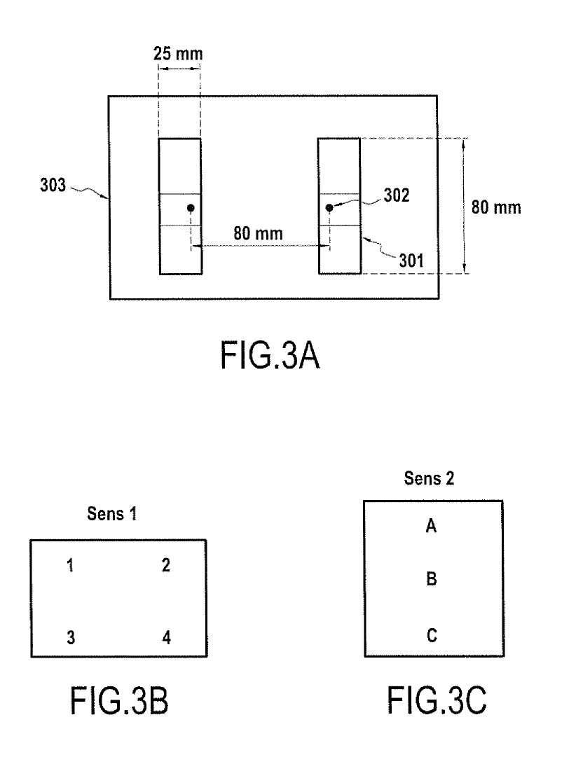

FIG. 3A is a schematic representation of the assembly used for resistivity measurements in the plane of the fabric and FIGS. 3B and 3C show the measurement points.

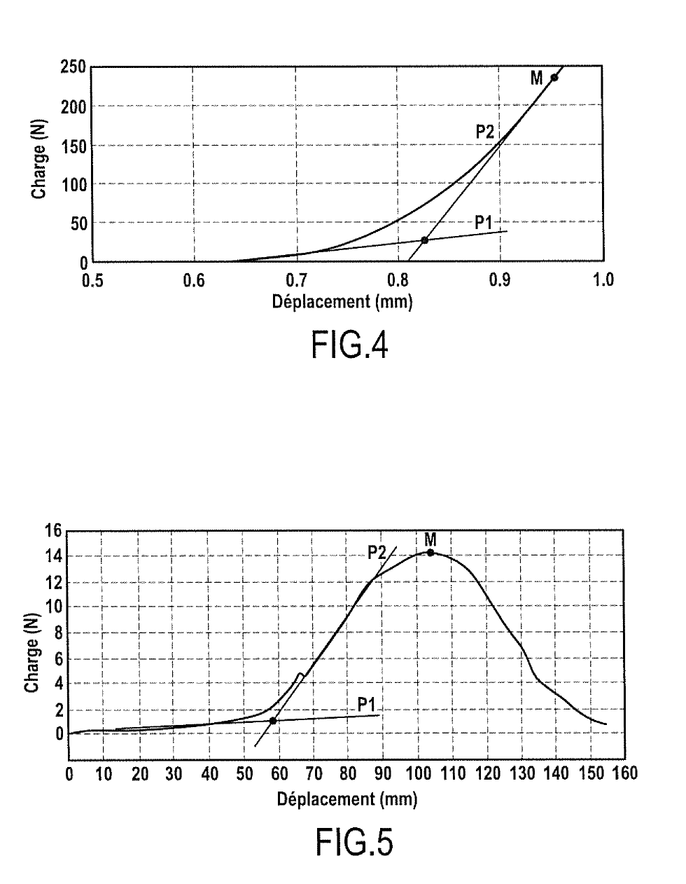

FIG. 4 illustrates the measurement of compressive stiffness and stress.

FIG. 5 illustrates the measurement of shearing stress.

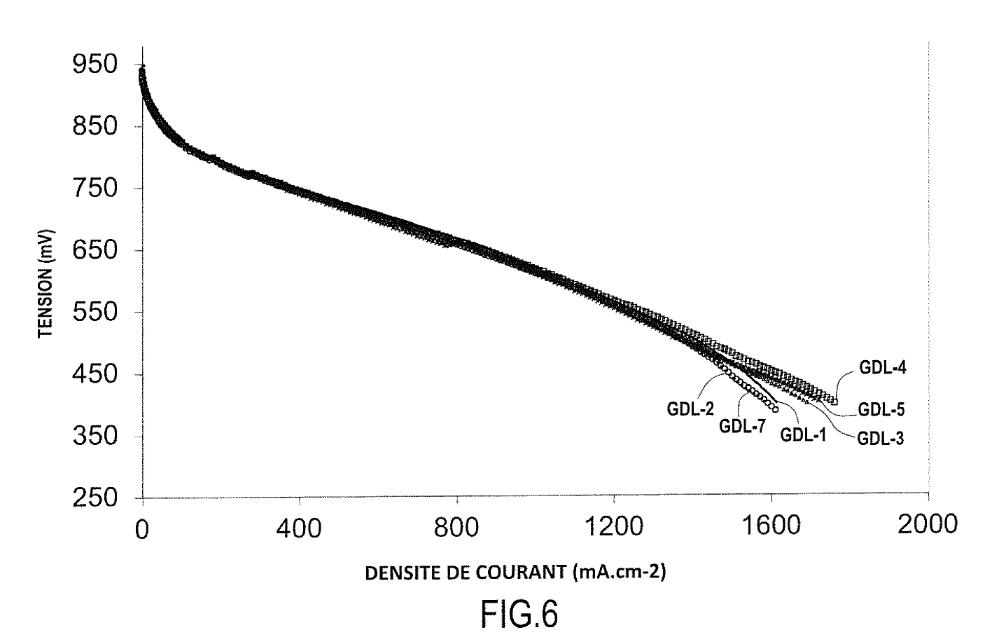

FIG. 6 shows the MEA polarization curves including a diffusion layer according to the invention (GILL-2, GDL-3, GDL-4, GDL-5 >and GDL-7) and a polarization curve of an MEA, including a diffusion layer not covered by the invention (GDL-1).

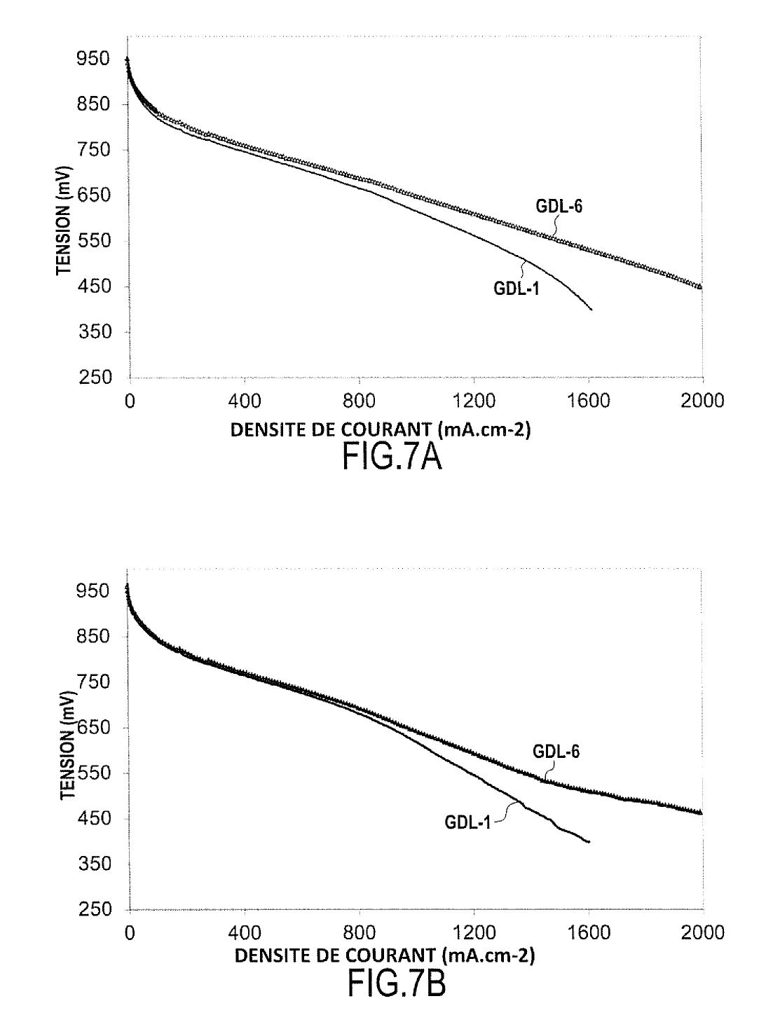

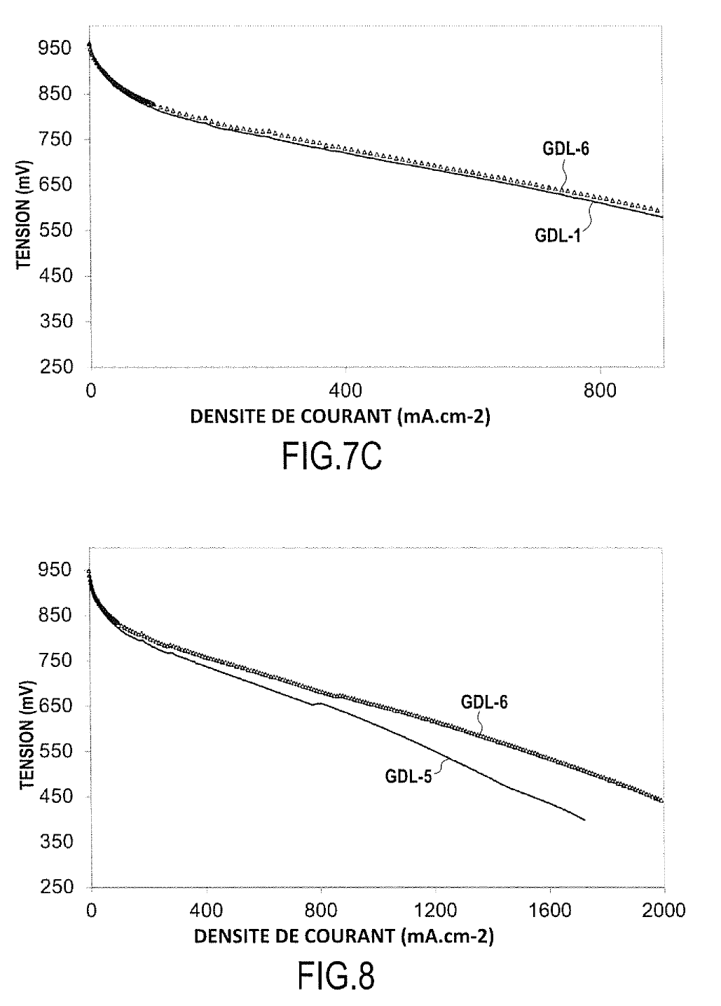

FIGS. 7A, 7B, 7C show the MEA polarization curves including a diffusion layer according to the invention (GDL-6) and a diffusion layer not covered by the invention (GDL-1), for conditioning under different temperature and humidity conditions.

FIG. 8 shows the MEA polarization curves including a diffusion layer according to the invention (GDL-5) and a diffusion layer according to the invention for which needling conditions have been optimized (GDL-6).

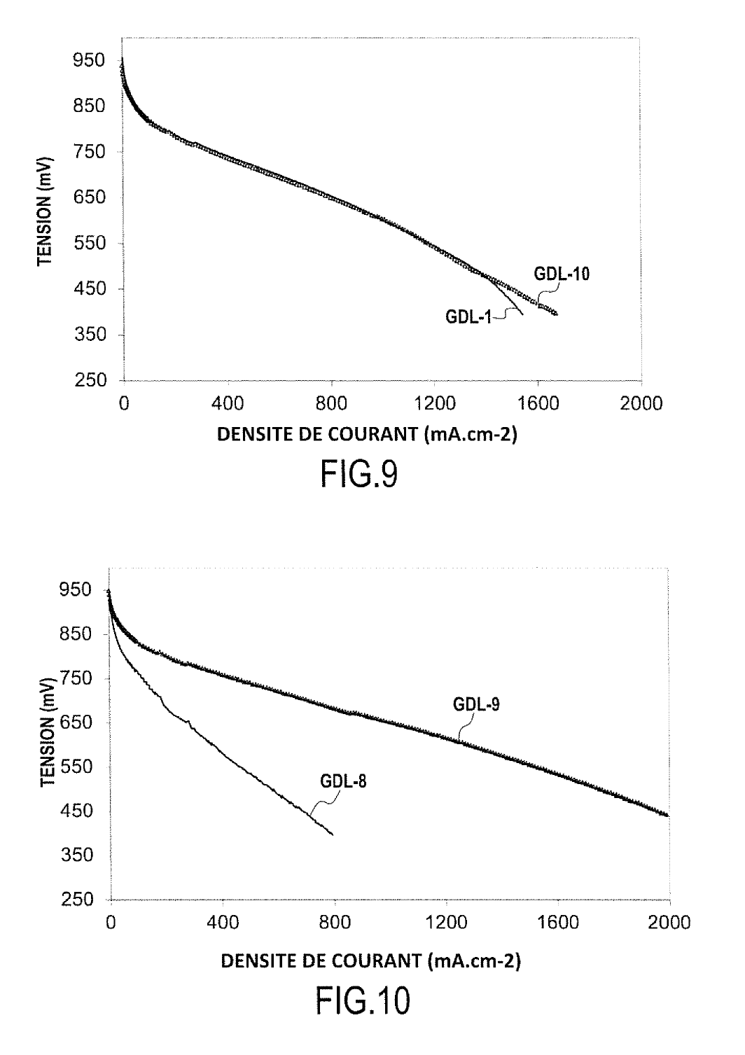

FIG. 9 shows the MEA polarization curves including a diffusion layer according to the invention (GDL-10) or a diffusion layer not covered by the invention (GDL-1).

FIG. 10 shows the MEA polarization curves including a diffusion layer according to the invention (GDL-9) and a diffusion layer not covered by the invention (GDL-8), corresponding to a non-needled fabric.

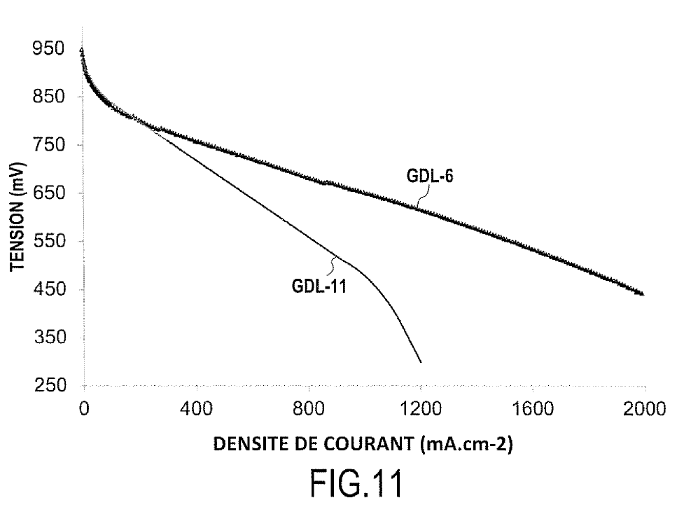

FIG. 11 shows the MEA polarization curves including a diffusion layer according to the invention (GDL-6) and a diffusion layer not covered by the invention (GDL-11), corresponding to a needled multiaxial sheet.

### DETAILED DESCRIPTION

### Fabric According to the Invention

The present invention relates to a fabric comprising carbon threads, said fabric having a mass per unit area within the range of 40 g/m² to 100 g/m², preferably within the range of 40 g/m² to 80 g/m², specifically within the range of 60 g/m² to 80 g/m², and characterized in that it comprises staple fibers, said staple fibers extending out from the component threads of the fabric from which they originate and extending in a direction that is not parallel to the direction of the thread from which they originate and/or in that the fabric is needled.

By “fabric,” we mean a consistent assembly of warp threads and weft threads by weaving; that is, with intersections and interlacings.

By “mass per unit area,” we mean the ratio of the mass of a piece of fabric relative to its surface area. The mass per unit area may be measured according to the ISO3374 standard.

The fabrics defined in the framework of the invention are preferably composed of at least 90% by weight, or are even exclusively constituted by, carbon threads. When the fabrics are not exclusively composed of carbon threads, the at most 10% by weight of the fabric may be composed of polymer-based sizing and/or of other threads composing said fabrics, which may be glass threads, polymer threads, or hybrid glass/polymer threads.

The warp threads and weft threads are preferably all carbon threads. More specifically, the warp threads are identical carbon threads and the weft threads are identical threads, or the warp threads and the weft threads are all identical.

A carbon thread is constituted of an assembly of filaments and generally has from 1000 to 80000 filaments (this is referred to as 1 to 80K thread), advantageously from 3000 to 24000 filaments. The filaments can move freely relative to each other. The same is true for the carbon threads. A filament is characterized by being very long and can be referred to as a continuous fiber.

Advantageously, the mass per unit length of a thread, specifically of a carbon thread, falls within the range of 0.03 to 4 g/m, and preferably within the range of 0.2 to 2 g/m.

Advantageously, the number of warp or weft threads falls independently within the range of 0.4 to 2 threads/cm.

The fabrics according to the invention are characterized by the presence of staple fibers extending out from at least one section of the constitutive threads of the fabric. A staple fiber corresponds to a filament that is still attached to the thread, but that has been cut while remaining integrated into the thread. A staple fiber extends in a direction that is not parallel to the direction of the thread from which it originates. This is referred to as disorientation of the staple fiber relative to the thread from which it originates and from which it extends. This disorientation corresponds to a change in orientation in a carbon thread of at least one filament due to its being cut and therefore due to the creation of a staple fiber, in particular outside the plane of the fabric and/or outside weaving lines. Preferably, the change in orientation of at least one cut filament corresponding to a staple, fiber in a carbon thread occurs outside the plane of the fabric; that is, along its thickness.

By “extends in a direction that is not parallel to the direction of the thread,” we mean a fiber obtained by cutting a filament comprised inside a thread, which diverges from the general direction of said thread, in particular which diverges from the longitudinal axis of said thread.

More specifically, a staple fiber corresponds to a filament of which one end is free or cut. This cut end corresponds to a staple fiber and essentially forms a fork or branch on the thread inside which the filament is present; this is why we say that it extends out from said thread. The staple fibers may originate from warp threads and/or weft threads.

Some of the staple fibers are located on the surface of the fabric, creating a certain hairiness on the fabric, while some of the staple fibers are located within the thickness of the fabric, as illustrated in FIG. 1B and on the zoom shown in FIG. 1C. The fibers located within the thickness of the fabric may extend parallel to the plane of the fabric or along the thickness of the fabric; that is, not parallel to the plane of the fabric. We say that a fiber extends along the thickness of the fabric if it forms any non-null angle with the plane of the fabric; this angle may be equal to 90° or it may correspond to any value within the range of 0 to 90°. The orientation of the staple fibers along the plane of the fabric or along the thickness of the fabric—that is, extending in a plane that is different from the plane of the fabric—may be observed by photos taken by a microscope.

The staple fibers present on the surface preferably extend, for the most part, out of the fabric or emerge from the surface of the fabric, thereby conferring a certain hairiness to the fabric.

The staple fibers within the fabric and the disorientation of these fibers relative to the fibers from which they originate may be obtained by mechanically breaking certain filaments constituting the carbon threads, performed by the penetration of at least one punch element that may be a needle-type unit, in particular a barb needle, or the jet of a fluid such as air or water. This type of technique, regardless of the punch element used (physical unit or jet), is referred to as needling. The penetration and withdrawal of the needle or of the pressure of the fluid also makes it possible to disorient the cut filaments and to orient the obtained staple fibers in several directions. Advantageously, needling makes it possible to cause at least part of the obtained staple fibers to penetrate into the thickness of the fabric, such that these fibers lie along the thickness of the fabric.

By “needled fabric,” we mean a fabric that has undergone a needling operation. The result of needling is that the fabric is composed of threads, specifically carbon threads, some filaments of which are cut and form staple fibers extending out from said cut filament in a direction that is not parallel to the general direction of the thread from which they originated. At least a portion of these staple fibers are located within the thickness of the fabric. Some of the staple fibers are located on the surface of the fabric, creating a certain hairiness on the fabric, while some of the staple fibers are located within the thickness of the fabric, as illustrated in FIG. 1B.

A cross-section of a fabric prior to needling is shown schematically in FIG. 1A. This fabric includes an intersection and an interlacing of warp threads 1 and weft threads 3. The warp threads 1 and the weft threads 3 are composed of filaments 2 and 4 respectively. The thickness of the fabric is symbolized by the arrow 5 and the fabric extends along a plane P, the two sides S of the fabric (also referred to as the broad side) being parallel to this plane, given the consistent thickness of the fabric.

By “plane of the fabric,” we mean the median plane of the fabric extending parallel to these two broad sides (as opposed to the other sides of the fabric along the thickness, which are referred to as the small sides, since the thickness corresponds to the smallest dimension of the fabric).

A cross-section of a fabric after needling is shown schematically in FIG. 1B. This fabric still includes an intersection and interlacing of the warp threads 1 and of the weft threads 3. Fibers 6, which originate from the filaments of the warp threads and weft threads, may be oriented in the plane of the fabric or in its thickness. In FIG. 1C, which is a zoom of the cross-section of the fabric shown in FIG. 1B, we see staple fibers 6a that extend parallel to the plane of the fabric, staple fibers 6b that extend along the thickness of the fabric, while remaining within the thickness of the fabric, and staple fibers 6c that extend along the thickness of the fabric while protruding from the latters surface.

Advantageously, the fabric of the invention is needled with an impact density falling within the range of 50 to 650 impacts/cm²/side, specifically within a range of 55 to 300 impacts/cm?/side, preferably within a range of 60 to 140 impactsicm²iper side; the impacts may be made from only one side of the fabric or from both of its sides.

It is particularly preferred, in the framework of the invention, that carbon threads of 1 to 48K, e.g., of 3K, 6K, 12K or 24K, and preferably from 3 to 24K, be used. For example, the count of the carbon threads used in the fabrics ranges from 100 to 3200 Tex, specifically from 200 to 1600 Tex.

The fabric may be made with any type of carbon thread, e.g., High Resistance (HR) threads, whose tensile modulus ranges from 220 to 241 GPa and whose tensile breaking stress generally ranges from 3000 to 5000 MPa, Intermediate Module (IM) threads, whose tensile modulus ranges from 280 to 300 GPa and whose tensile breaking stress generally ranges from 3450 to 6200 MPa, and High Module (HM) threads, whose tensile modulus ranges from 301 to 650 GPa and whose tensile breaking stress ranges from 3450 to 5520 Pa (according to the “ASM Handbook,” ISBN 0-87170-703-9, ASM International 2001).

The constitutive threads of the fabric may or may not be sized, most often, in this case with a standard sizing weight content that may represent up to 2% of their weight.

The weave of the fabric according to the invention, preferably needled, may be taffeta (also referred to as straight weave), twill, basket weave, satin, or a derivative of these weaves, preferably taffeta. A taffeta weave gives the fabric greater strength and has a greater number of comings-and-goings of threads between the two broad sides of the fabric than other weaves.

The fabric of the invention, preferably needled, is a fabric that is at least partially constituted of carbon threads having a mass per unit area within the range of 40 g/m² to 100 g/m², preferably within the range of 40 g/m² to 80 g/m², specifically within the range of 60 g/m² to 80 g/m².

The fabric according to the invention, preferably needled, has an open factor within the range of 0% to 18%, preferably within the range of 0% to 10%. The open factor may be defined as the ratio multiplied by 100 between the surface area not occupied by the material and the observed total surface area; this observation can be performed by looking at the top of the fabric while the fabric is lit from underneath. The open factor (OF) is expressed as a percentage. It can, e.g., be measured according to the method described in the examples.

The fabric according to the invention, preferably needled, has a surface resistance measured in the plane of the fabric that is less than or equal to 7 Ohms.

By “surface resistance,” we mean the fabric's ability to block the circulation of electric current. The surface resistance is measured at ambient temperature (22° C.) via the displacement of electrodes over a broad side of the fabric and taking an average of these measurements. The experimental conditions for performing this measurement are provided in detail in the Example section.

The fabric according to the invention, preferably needled, has a resistance, measured in the plane that is transverse to the plane of the fabric and on a stack of four superimposed folds of the same fabric, that is less than or equal to 0.5 Ohms. Since the needled fabric of the invention is very fine, it seemed more representative to measure the resistance in the plane transverse to the plane of the fabric (that is, along its thickness) on a stack of 4 folds of a single piece of fabric. A fold is the basic entity that forms the fabric. The experimental conditions for taking this measurement are provided in detail in the Example section.

The fabrics according to the invention that have staple fibers that extend both in the plane of the fabric and along its thickness offer the advantage of having electrical conductivity in three dimensions. This electrical conductivity is therefore distributed in the direction of length, width, and thickness of the fabric. This improved distribution of conductivity in these three dimensions improves the performance of the diffusion layer.

The needled fabric according to the invention preferably has an average thickness, measured according to the ISO5084 standard, that is less than or equal to 400 μm, specifically less than or equal to 350 μm, preferably within a range from 35 μm to 300 μm.

The needled fabric according to the invention preferably has an air permeability, measured according to the EN ISO9237 standard, that is less than or equal to 5000 m², preferably less than or equal to 3000 m².

The needled fabric according to the invention has a water permeability that is less than or equal to 9.10⁻¹² m² for a fiber volume content of 10%; less than or equal to 9.10⁻¹³ m² for a fiber volume content of 30%; and less than or equal to 2.10⁻¹³ m² for a fiber volume content of 50%.

The fiber volume content (FVC) of a fabric is calculated based on the measurement of the fabric's thickness, with the mass per unit area of the fabric and the properties of the carbon threads used being known, using the following equation:

$$TVF ( \% ) = \frac{Masse surfacique {T}_{carbone}}{{ρ}_{fil carbone} \times {e}_{tissu}} \times {10}^{- 1} \qquad ( I )$$

[Key: TVF=FVC; Mass surfacique=Mass per unit area; fil carbone=carbon thread; tissu=fabric]

In which eₜᵢₛₛᵤ is the thickness of the fabric in mm, measured according to the ISO 5084 standard, ρ_{fil carbone} is the density of the carbon threads in g/cm³, and T_{carbone} is the mass per unit area of the fabric in g/m².

The needled fabric according to the invention preferably has a compressive stiffness (P2) that is greater than or equal to 1200 N/mm, specifically higher than or equal to 1500 N; mm. Compressive stiffness is measured using the method described in the experimental section.

The needled fabric according to the invention preferably has a compressive stress that is less than or equal to 350 N, specifically less than or equal to 300 N, said compressive stress being measured for a fiber volume content (FVC) equal to 47%. The method for measuring this compressive stress for a fiber volume content of 47% is mentioned in the examples.

The needled fabric according to the invention preferably has a maximum shear load, measured under 45° of traction, that is greater than or equal to 8 N, specifically greater than or equal to 10 N. This maximum shear load is measured on a fabric whose warp and weft threads and oriented at 45° relative to the direction of the applied force. This method is described in the experimental section.

The global porosity value (Po) of the needled fabric according to the invention is obtained according to the following formula:

Po(%)=100−FVC (%),

With the FVC being calculated based on Formula (I) above.

### Method for Manufacturing a Fabric According to the Invention by Needling

Another aim of the invention relates to a method for manufacturing a fabric according to the invention by needling; the method includes the following steps:
using at least one fabric including, even composed of, carbon threads and having a mass per unit area within the range of 40 g/m² to 100 g/m², preferably within the range of 40 g/m² to 80 g/m², specifically within the range of 60 g/m² to 80 g/m²;
needling said fabric on at least one of its broad sides.

More specifically, it is possible to use a fabric as described in the patent application WO 2014/135806 and/or one that is likely to be produced according to the method disclosed in this patent application, to which one may refer for additional details; this application spreads the threads in order to obtain the low weight desired. In particular, the fabrics as defined in the claims of this published patent application may be used. The spreading of the fabric may be performed on-line or off-line.

More particularly, prior to the needling step, the fabric will have the following features, determined according to the techniques discussed in patent application WO 2014/135806, to which the reader may refer for additional details:
a mass per unit area that is greater than or equal to 40 g/m² and less than 100 g/m² and a standard deviation of thickness measured on a stack of three identical pieces of fabric, placed one atop the other and along the same direction, that is less than or equal to 35 μm,
a mass per unit area that is greater than or equal to 40 g/m² and less than 100 g/m², a standard deviation of thickness measured on a stack of three identical pieces of fabric, placed one atop the other and along the same direction, that is less than or equal to 35 μm and an average open factor of no more than 1%, preferably with an open factor variability of no more than 1% and/or with the fabric being preferably constituted of threads having a count of 200 to 3500 Tex, and preferably of 200 to 1700 Tex, specifically of 200 to 1600 Tex.

In a specific embodiment, the fabric has an open factor, prior to the needling step, within the range of 0% to 5%, specifically within the range of 0% to 1%. To achieve open factors, prior to needling, that are greater than 1%, the stretching of the fabric to undergo needling will be less than what is described in patent application WO 2014/135806.

The needling step is performed by the penetration of at least one punch element, which may be a needle-type unit or a jet of a fluid. Penetration is performed from at least one broad side of the fabric, preferably along a direction that is transverse to the plane of the fabric (that is, transverse to its two broad sides). The fluid may be air or water. Needling makes it possible to disorient and cut some of the constitutive filaments of the woven carbon threads by causing said punch element to penetrate the fabric. Needling causes some of the constitutive filaments to break, as described previously in the “Fabric According to the Invention” section, thereby creating staple fibers, said staple fibers extending out from the constitutive threads of the fabric from which they originate and extending in a direction that is not parallel to the direction of the thread from which they originate. The needling operation increases the fabric's porosity level by increasing its thickness; its variations may vary depending upon the needling parameters. In certain cases, needling may tend to increase, to a variable extent, the open factor of the fabric.

The impact or penetration density ranges from 50 to 650 irnparts/cm², specifically within a range of 55 to 300 impacts/cm², preferably within the range of 60 to 140 impacts/cm², per side. By “impact density,” we mean the number of penetrations made on a broad side per cm² of this broad side. The impact density may be identical for each side of the fabric or may be different from one broad side to the other. The needling step will be performed homogeneously over the entirety of at least one broad side of the fabric. The total impact density, whether the penetration is performed on only one or on both broad sides, ranges from 50 to 1300 impacts/cm², specifically from 55 to 600 impacts/cm², preferably from 60 to 280 impacts/cm². For penetration of both broad sides, the total impact density corresponds to the sum of the impact densities made on each of the broad sides. For needling made on both sides, the penetration elements will preferably be positioned such that they are offset from one side to the other.

The needling step may be performed on one broad side of the fabric or on both of its broad sides. In the latter case, the broad sides may be needled simultaneously or one after the other; in other words, sequentially.

If needling is performed using a needle-type unit or units, the unit(s) will penetrate and then withdraw. The unit is a barbed needle. A barb is a part that protrudes from or is recessed into the needle whose function is to cut and/or to catch onto some of the filaments in order to make them penetrate into the thickness of the fabric. Using a barbed needle makes it possible, during penetration, to carry along filaments from the penetration surface; withdrawal leads to the penetration of filaments from the other side.

In a preferred embodiment, the needling step is performed via penetration of a needle that preferably comprises at least one barb. The needles are generally metallic, may be of several sizes, may have a specific profile with various numbers of barbs, which may in turn have specific sizes and profiles. A person skilled in the art will be able to select the needles based on the needling conditions and the fabric to be needled.

For a barbed needle, we refer to as the ‘useful portion of the needle’ the distance separating the tip of the needle from the barb that is farthest from the tip, including said barb.

Barbed needles have a vertical profile and a horizontal profile. The vertical profile corresponds to the cutting plane in the longitudinal direction of the needle. The horizontal plane corresponds to the cutting plane in the radial direction of the needle. The useful portion of the needle may have, e.g., a triangular horizontal profile; that is, formed of three ribs, or a star-shaped profile; that is, formed of a 4-branch (or -rib) star with angles within the range of 30° to 90°, preferably within the range of 30° to 70°, even more preferably from 30° to 50° . The useful portion of the barbed needles used has a triangular horizontal profile, which encourages, based on the orientation of the needle, the disorientation created by needling on the warp threads or the weft threads.

The vertical needle profile may be standard (straight) or conical, preferably straight.

The needle has at least one barb or a plurality of barbs, preferably 2, 3, 4, 5, 6, 7, 8, 9 barbs, or more, the barb or barbs being placed over a useful length within the range of 3 to 30 mm.

The number of barbs per rib may be less than or equal to 3; preferably, it may be equal to 1.

The overall width of the useful portion of a needle at the level of a barb may be less than or equal to 3 mm, preferably within a range of 0.3 to 1 mm.

A barb is defined by a height and a depth. The depth is the maximum distance separating the body of the needle from the farthest-protruding portion of the barb. The depth of a barb falls, e.g., within a range of 0.05 to 2 mm, preferably within a range of 0.05 mm to 0.5 mm. The length of a barb on the body of the needle preferably falls within the range of 0.1 to 2 mm.

Barbed needles are, e.g., sold by Groz Berckert KG. One may select, e.g., needles with KV bars, HL barbs, or RF barbs, preferably needles with KV barbs or HL barbs.

The penetration will preferably be performed with at least one barbed needle, on at least one broad side of the fabric, and over a distance enabling the penetration of at least one barb, and even the penetration of all of the barbs present on the needle.

As is traditional in needling techniques, in order to cut filaments, at least part of the penetrations of the needle or needles used, even all of the penetrations, will be performed by orienting the vertical profile of the needle such that at least one of the barbs present on the needle is oriented non-parallel to the first of the threads that it will encounter upon its penetration.

All of the features provided concerning needling in this section, “Method for Manufacturing a Fabric According to the Invention by Needling,” and/or in the “Fabric According to the Invention” section, apply to the needled fabric according to the invention; that is, to the fabric obtained upon completion of needling.

### Diffusion Layer

Another aim of the invention relates to a fuel cell diffusion layer including at least one fabric as defined in the framework of the invention or one likely to be obtained by the manufacturing method as defined in the framework of the invention, said fabric including at least one hydrophobic coating.

By “coating,” we mean at least one element that covers at least partially, preferably entirely, at least one surface of the fabric, even both, and that preferably penetrates into the fabric, more preferably into its core—in other words, up to the median zone of the fabric, referred to as the core.

By “hydrophobic coating,” we mean at least one coating that repels water. A coating of this type includes at least one hydrophobic agent.

The hydrophobic coating enables the diffusion layer to discharge water by creating preferential liquid water discharge zones. The hydrophobic coating prevents the water from collecting inside the pores of the diffusion layer. It also prevents blocking of the passage of reagent gases between the membrane and the active layers.

The hydrophobic coating is obtained from a liquid composition that will be deposited onto the support. Before it is deposited, this liquid composition includes at least one hydrophobic agent in suspension in a solvent such as water, ethanol, propanol, ethylene glycol, and mixtures thereof.

The hydrophobic agent, can be selected from polytetrafluoroethyle e (PTFE) and fluorinated ethylene propylene (FEP).

In one embodiment, the, hydrophobic coating additionally includes carbon nanofibers. In this case, such carbon nanofibers are present in the liquid composition, preferably with at least one dispersing agent. Advantageously, the mixture of carbon nanofibers and hydrophobic agent increases the conductivity and stiffness of the fabric, and therefore improves the performance of the diffusion layer.

By “carbon nanofibers,” we mean a carbon fiber whose diameter falls within the range of 20 to 1000 nm, preferably 100 to 500 nm, and whose length falls within the range of 1 to 100 μm, preferably 50 to 100 μm. Carbon nanofibers of particular interest are VGCFs (Vapor Grown Carbon Fibers), and specifically the VGCF®-Hs sold by Rhodia (France). By “dispersing agent,” we mean any chemical agent that prevents the clumping of carbon particles, specifically carbon nanofibers. The dispersing agent can be selected from nonionic or anionic surfactants such as Triton X100, Nafion, or Brij.

After the composition is deposited, the support undergoes a heat treatment, as explained below, leading to the final hydrophobic coating, which can be termed dry.

In one embodiment, the hydrophobic coating includes from 10 to 100% by weight, preferably from 40 to 50% by weight of at least one hydrophobic agent relative to the total weight of the hydrophobic coating. In another embodiment, the hydrophobic coating includes, or is even constituted of, 10 to 30% by weight, preferably 20 to 25% by weight of at least one hydrophobic agent and of 70 to 90% by weight, preferably 75 to 80% by weight of carbon nanofibers relative to the total weight of the hydrophobic coating. These various percentages correspond to the final support; that is, after the heat treatment steps that result in the elimination of the other compounds present in the applied composition, such as the dispersing agent.

Advantageously, the hydrophobic coating placed onto the fabric represents 70 to 120%, specifically 70 to 90%, by weight relative to the weight of the fabric prior to treatment. This quantity yields a di usion layer with good performance in terms of electrical conductivity.

In one embodiment, the diffusion layer of the invention may a inc de at least one microporous layer.

By “microporous layer,” we mean a laye whose pore diameter of said microporous layer ranges from 0.01 to 10 μm, preferably from 0.1 to 1 μm. The pore diameter is measured by scanning electron microscopy. The pores of the microporous layer are smaller than those of the diffusion layer. The microporous layer acts as an interface between the diffusion layer and the active layer and improves the performance of the fuel cell by acting upon water management. This improved performance is obtained by the various properties of the microporous layer, specifically by the micrometric pores. The pore size produces better distribution of gases over the entire surface area of the fuel cell. Moreover, the decrease in the size of pores between those of the diffusion layer fabric and those of the microporous layer accelerates the passage of gases and therefore decreases condensation.

The microporous layer also participates in the electrical conductivity of the diffusion layer. The microporous layer, being generally made of carbon black for the most part, facilitates the transport of electrons from the active layer to the outside network. Thanks to high compatibility between the active layer and the diffusion layer, the microporous layer improves the interface between the active layer and the diffusion layer, and hence decreases the contact resistance between these two layers.

The fabric that bears the hydrophobic coating may be combined with a microporous layer, on only one of its broad sides or on both of its broad sides. By “combined,” we mean that the microporous layer(s) is/are integrated into the fabric.

The microporous layer is deposited in the form of a liquid composition on the fabric that bears the hydrophobic coating. It may include carbon black and at least one hydrophobic agent selected from tetrafluoroethylene and fluorinated ethylene propylene. Carbon black increases the conductivity of the diffusion layer by facilitating the transfer of electrons from the active layer to the diffusion layer. The hydrophobic agent, in the microporous layer, improves water management inside the fuel cell. It makes it possible to keep water at, the active layer and at the membrane, thereby enabling good hydration of these components; it also makes it possible to discharge the water at the pores of the diffusion layer to be discharged more quickly.

In one embodiment, the microporous layer may additionally include carbon nanofibers.

The carbon nanofibers prevent cracking of the microporous layer deposit during evaporation of the solvent that is present in the deposited liquid composition. It consolidates the structure without altering its electrical conductivity. The carbon nanofibers are selected from VGCFs (Vapor Grown Carbon Fibers), and more specifically will be the VGCF®-H nanofibers sold by Rhodia (France).

In one embodiment, the microporous layer may include, and may even be constituted of, 30 to 45% by weight, preferably 35 to 40% by weight of carbon black, of 5 to 20% by weight, preferably 8 to 15% by weight of at least one hydrophobic agent, and of 35 to 65% by weight, preferably 40 to 60% by weight of carbon nanofibers, the percentages being expressed relative to the total weight of the microporous layer. Here again, these percentages correspond to the final support, namely following the heat treatment steps, which lead to the elimination of the other compounds present in the applied compositions in order to form the diffusion layer, as is explained below.

In one embodiment, the quantity of microporous layer deposited on the fabric that has a hydrophobic coating ranges from 1 to 3 mg/cm², preferably from 2.3 to 2.7 mg/cm².

### Diffusion Layer Manufacturing Method

Another aim of the invention is a method for manufacturing a diffusion layer including at least the following steps:
having at least one fabric as defined in the framework of the invention or likely to be obtained according to the method as defined in the framework of the invention,
having at least one liquid composition for forming a hydrophobic coating,
depositing said liquid composition onto said fabric,
heat-treating said fabric onto which the liquid composition has been deposited.

The liquid composition for forming a hydrophobic coating is obtained by mixing and placing at least one hydrophobic agent into suspension in a solvent, such as water.

During the treatment, the fabric may be constrained in order to obtain a predetermined thickness, which preferably ranges from 100 to 300 μm measured according to the ISO5084 standard.

When the liquid composition, in order to form the hydrophobic coating, include other ingredients in addition to the hydrophobic agent, it is obtained as follows: at least one dispersing agent and carbon nanofibers are added to the hydrophobic agent in the solvent, such as water. This liquid composition is homogenized using a homogenizer, which includes an enclosure, so as to obtain a suspension. The homogenizer may be, e.g., a Dispermat. The shaft of the homogenizer rotates at a speed within the range of 1500 to 2500 rpm, with a residual pressure inside the enclosure within the range of −700 to −950 mbar, preferably −900 mbar, relative to atmospheric pressure. The liquid composition can be homogenized for a duration of 15 min to 25 min. This homogenization step breaks up the clumps which are present and eliminates gases which may be trapped inside the composition. A dispersed and fluid composition is obtained whose viscosity ranges from 0.8 to 1.1 mPa.s. This viscosity makes it possible to obtain a homogeneous hydrophobic coating on the fabric that acts as a support.

In one embodiment, the liquid composition for the hydrophobic coating can include 1 to 10% by weight, preferably 2 to 4% by weight of at least one hydrophobic agent and from 90 to 99% by weight, preferably at least from 96 to 98% by weight of solvent such as water; the percentages by weight are expressed relative to the total weight of the liquid composition.

In another embodiment, the liquid composition for the hydrophobic coating, may include from 0.5 to 3% by weight, preferably from 1 to 1.5% by weight of at least one hydrophobic agent, from 0.01 to 1% by weight, preferably from 0.1 to 0.5% by weight of at least one dispersing agent, from 1 to 5% by weight, preferably from 2 to 3% by weight of carbon nanofibers and from 80 to 99% by weight, preferably from 92 to 98% by weight of solvent such as water; the percentages by weight are expressed relative to the total weight of the liquid composition and their sum is preferably equal to 100%.

The liquid composition can then be deposited onto the fabric as defined in the framework of the invention or likely to be obtained according to the method as defined in the framework of the invention. Depositing is most often performed on the two broad sides of the fabric along with core soaking. The depositing can be performed using various techniques well known to a person skilled in the art, such as core soaking or spray soaking, surface depositing using a roller press or an impregnator. Preferably, the depositing of the liquid composition for the hydrophobic coating can be performed by soaking and consists of submerging the needled fabric of the invention for a duration of 10 to 300 seconds. The contact time between the fabric and said liquid composition, along with the viscosity of this liquid composition, control the quantity of liquid composition soaked into the fabric.

The heat treatment step can be performed, e.g., at a temperature within the range of 200° C. to 450° C., preferably from 250 to 3503° C., under air. This step enables the consolidation of the hydrophobic coating, in particular by sintering of the hydrophobic agent, as well as the evaporation of additives such as the solvent and the dispersing agent (if present).

According to a preferred embodiment, the diffusion layer may also include a microporous layer. In this case, the diffusion layer can be obtained according to the method including the following successive steps:
having at least one liquid composition for forming a microporous layer,
depositing said liquid composition over at least one broad side of the fabric obtained following the heat treatment step,
heat-treating said fabric onto which the composition is deposited.

The liquid composition that will form the microporous layer is generally deposited onto a single broad side of the support bearing the hydrophobic coating. This broad side will be positioned inside the GILL on the electrode side

In general, the heat treatment that should, in the end, lead to sintering of the composition will be preceded by an intermediary step for drying the fabric onto which the liquid composition has been deposited.

The liquid composition for forming a microporous layer may include at least one hydrophobic agent, carbon black, and at least one solvent such as water, ethanol, propanol, ethylene glycol, and mixtures thereof.

The hydrophobic agent is selected from polytetrafluoroethylene (PTFE) and fluorinated ethylene propylene (FEP).

The features of the hydrophobic agent are preferably the same as those mentioned for the hydrophobic agent of the liquid composition for obtaining the hydrophobic coating.

The same holds true for the solvent present in the composition for the constitution of the microporous layer: it is preferably selected from water, ethanol, propanol, ethylene glycol, and mixtures thereof.

The liquid composition may include 2 to 4% by weight, preferably from 2.5 to 3.5% by weight, of at least one hydrophobic agent, from 1 to 6% by weight, preferably from 3 to 4% by weight, of carbon black and 70 to 95% by weight, preferably 85 to 90% by weight of at least one solvent, such as water; the percentages are expressed relative to the total weight of the liquid composition and their sum is preferably equal to 100%.

According to one embodiment, the liquid composition for forming a microporous layer may additionally include at least one viscosif er, at least one dispersing agent, and at least carbon nanofibers.

The carbon nanofibers are carbon fibers whose diameter ranges from 20 to 1000 nm, preferably from 100 to 500 nm, and having a length within the range of 0.01 to 10 μm, preferably within the range of 0.1 to 1 μm. Carbon nanofibers of particular interest are VGCFs (Vapor Grown Carbon Fibers), and VGCF®-Hs sold by Rhodia (France). The dispersing agent improves the dispersion of all of the components of the liquid composition by breaking up dumps. A homogeneous liquid composition is then obtained. The dispersing agent is selected from nonionic or anionic surfactants such as Triton X100, Nafion, Brij, etc.

The features of the carbon nanofibers and of the dispersing agent are preferably the same as those mentioned for the nanofibers and dispersing agent of the composition for obtaining the hydrophobic coating.

The viscosifier thickens the liquid composition to be deposited and makes it viscous so that it can be deposited onto the fabric with a hydrophobic coating. It thereby prevents this composition from penetrating said fabric when it is deposited. The viscosifier is selected from methylcellulose, carboxymethylcellulose, and hydroxypropylmethylcellulose.

In this embodiment, the liquid composition for forming the microporous layer includes from 2 to 4% by weight, preferably 2.5 to 3.5% by weight of at least one hydrophobic agent, from 1 to 6% by weight preferably from 3 to 4% by weight, of carbon black, from 0.1 to 5% by weight, preferably from 0.5 to 1.5% by weight of at least one dispersing agent, from 0.5 to 3% by weight, preferably from 1 to 2% by weight of at least one viscosifier, from 2 to 8% by weight, preferably from 4 to 5% by weight of carbon nanofibers, and from 80 to 99% by weight, preferably from 85 to 95% by weight of at least one solvent such as water; the percentages are expressed relative to the total weight of the solution and their sum is preferably equal to 100%.

The deposition of the liquid composition on at least one broad side of the fabric with a hydrophobic coating is performed by techniques well known to a person skilled in the art such as spray deposition, silkscreen deposition, and coating deposition.

Preferably, the deposition is performed using the coating method, which consists of spreading the liquid composition over at least one broad side of the fabric with a hydrophobic coating by the translational movement of a bar or a scraper. To manage the quantity of the liquid composition deposited onto said fabric, the thickness of the threading of the coating bar or the height of the scraper is adjusted, thereby making it possible to obtain the loads of liquid composition for producing the desired microporous layer.

After the liquid composition is spread onto said fabric, the latter can be dried, e.g., directly on the coating bar at a temperature within the range of 60° C. to 100° C. The drying time may range from 0.5 to 5 minutes. Drying may solidify the microporous layer by evaporating the solvent. The quantity of deposited microporous layer ranges from 1 to 3 mg/cm².

The fabric, preferably needled, having a hydrophobic coating and its deposited microporous layer can then undergo heat treatment for 1 hour 30 minutes to 2 hours 30 minutes, at a temperature within the range of 200° C. to 450° C., preferably of 250 to 350° C., under air. This step consolidates the microporous layer (specifically, via sintering of the hydrophobic agent) and evaporates all of the additives (viscosifiers, dispersing agent, etc.), leaving behind only the final components of the microporous layer (hydrophobic agent, carbon fibers, and carbon black).

### Fuel Cell

Another aim of the invention is a fuel cell including at least one diffusion layer, as defined in the framework of the invention or likely to be obtained by the method as defined in the framework of the invention.

By “fuel cell,” we mean a convertor of chemical energy into electric energy. Unlike a battery, which undergoes charging and discharging cycles, a fuel cell can operate continuously as long as it is supplied with reactive gases. The fuel cell can be a solid oxide fuel cell (SOFC), a molten carbonate fuel cell (MCFC), a phosphoric acid fuel cell (PAFC), a proton exchange membrane fuel cell (PEMFC), a direct methanol fuel cell (DMFC), or an alkaline fuel cell (AFC). Preferably, the fuel cell of the invention is a proton exchange membrane fuel cell.

FIG. 2 shows a fuel cell 21 according to the invention, specifically a proton exchange membrane fuel cell, including at least one electrochemical cell 22 and at least one electrical supply 23.

The electrochemical cell 22 includes at least one assembly 24 of a membrane with at least one electrode and generally two electrodes (MEA), at least one seal 102 and generally two seals 102 and 103, at least one bipolar plate 104 and in general two bipolar plates 104 and 105, and at least one diffusion layer 106 as defined in the framework of the invention or likely to be obtained by the method as defined in the framework of the invention and, in general, two diffusion layers 106 and 107 as defined in the framework of the invention or likely to be obtained by the method as defined in the framework of the invention.

The membrane-electrode assembly (MEA) 24 includes at least one membrane 101 and at least one electrode 108, in general, two electrodes 108 and 109.

### EXAMPLES

The invention will now be described in the following embodiments, which are provided for purely illustrative purposes and should in no way be interpreted as limiting its scope.

### A—Tested Supports

The supports for the diffusion layer that were tested are either a paper-type carbon fiber non-woven support, bearing a hydrophobic treatment and a microporous layer, hereinafter referred to as S-NT and sold as Sigracet 24 BC by the FuelCellsEtc company, or woven supports, or a stack of unidirectional sheets. This support has a mass per unit area of 100 g/m² and a thickness of 250 μm.

The features of the fabrics tested prior to needling are summarized in Table I below.

TABLE I

| | | Mass per unit | | Open factor ^{b} |
|---|---|---|---|---|
| | | area | Carbon | prior to |
| N° of fabric | Weave | (g/m²)^{a} | threads | needling |
| 1 | Taffeta | 98 | HR | <1% |
| 2 | | 75 | AS4 3K | |
| 3 | | 75 | IM | <1% |
| | | | IM7 6K | |

^{a}measured according to the ISO 3374 standard
^{b}measured according to the method described below.

Fabrics 1 to 5 are spread and obtained according to the methods described in patent applications WO 2014/135805 and WO 2014/135806.

The carbon threads are available from, e.g., Hexcel Composites.

A 0°/90°/90°/0° stack of 4 unidirectional sheets of carbon threads was also used as a support for a diffusion layer. Each unidirectional sheet has a mass per unit area of 50 g/m² and an open factor of 0% prior to needling. This stack undergoes needling on each of its sides (recto-verso).

### B—Needling Protocol

The fabrics or the multiaxial sheet are placed on a “needling” machine N°040938269 manufactured by Andritz Asselin-Thibeau S.A.S (Elbeuf, France).

The features of the right horizontal-profile and triangular vertical-profile needles and the needling conditions are listed in Table II below.

The needles used to obtain the fabrics S-1 and S-8 are SINGER type 15*18*32 3.5 BL, RB 30 A06/15 needles.

The needles used to obtain the fabrics S-1 to S-4, S-7, and S-8 have a KV-type barb profile.

The needles used to obtain the fabrics S-5 and S-6 have an HL-type barb profile.

The needles used to obtain the needled multiaxial sheet have a traditional-type barb profile (i.e., straight, non-conical).

TABLE II

| | | | Useful | | Number of | Needle | Density | |
|---|---|---|---|---|---|---|---|---|
| No of | | Needle | needle | | barbs (nb | penetration | of needle | |
| needled | | thickness * | length * | Barb size * | angles × nb | (side 1/side | impacts/ | Recto/ |
| fabric | Fabric | (mm) | (mm) | (d × h in mm) | barbs/angle) | 2 in mm) | cm²/side | verso |
| S-1 | 2 | Without needling | | | | | | |
| S-2 | | 1.1 | 22 | 0.35 × 1 | 3 × 3 | 20/20 | 69 | YES |
| S-3 | 2 | | | | | 20/0 | 69 | NO |
| S-4 | | 0.6 | 30 | 0.2 × 0.8 | 3 × 3 | 24/24 | 276 | YES |
| S-5 | | 0.5 | 15 | 0.1 × 0.35 | 3 × 1 | 24/24 | 621 | YES |
| S-6 | 2 | 0.5 | 15 | 0.1 × 0.35 | 3 × 1 | 24/24 | 69 | YES |
| S-7 | 3 | 1.1 | 22 | 0.35 × 1 | 3 × 3 | 20/0 | 69 | NO |
| S-8 | 1 | 0.7 | 30 | 0.3 × 0.7 | 3 × 3 | 12/12 | 138 | YES |
| S-9 | Multiaxial | 0.7 | 30 | 0.3 × 0.7 | 3 × 3 | 24/0 | 138 | NO |
| | sheet | | | | | | | |

(*) Tolerance of dimensions not known

### C—Characterization of Fabrics

### C1—Resistance Measurement on Fabric

The measurement means implemented for measuring surface resistance in the plane of the fabric and for measuring resistance in the plane that is transverse to the plane of the fabric are as follows:
Keithley'3706A system switch/multimeter apparatus
Keithley LXI Discovery Browser software program
LAV measurement gauge
Copper plates measuring 25 mm/80 mm

### C1.1 Measurement of Surface Resistance in the Plane of the Fabric

Measurements of surface resistance are taken as follows:

For the calibration of the assembly, the copper conductor electrodes 301 (2.5 cm wide and 8 cm long) are placed on the same side of the fabric 303 at a distance 80 mm apart from each other, as shown in FIG. 3A.

The gauge is designed such that R_{square}=R_{read}
R_{square} is equal to R×(w/L), with R being the read resistance, w being the measured width of the support (80 mm), and L being the distance between the closest electrodes (80 mm).

The electrodes are plugged in to measure 4 peaks with the micro-ohmmeter and the micro-ohmmeter is set on measurement 4Wω Auto. The fabric sample is placed on a hard, flat surface.

For the sample measurement, we first place the 2 copper plates onto the sample. If an oxidation layer is present on the plates, we first remove it with a sander, e.g., an orbital sander. The oxidation layer may harm the accuracy of the measurement. We then place the gauge on top, while placing the copper plates in the appropriate areas. We press the gauge lightly onto the electrodes.

Next, we launch the measurements (also referred to as “loop measure”), then we place the 2 electrodes into the holes of the gauge 302, pressing lightly on the surface of the copper plates. We wait for several seconds in order to determine several measurements, then we remove the electrodes and stop the measurements.

7 measurements are taken per fabric to be tested by moving the electrodes with the gauging device on the sample of the fabric to be tested. 4 measurements are taken in a horizontal direction (direction n°1, FIG. 3B) and 3 measurements are taken in the vertical direction (direction n°2, FIG. 3C).

The value of the surface resistance corresponds to the average of these 7 measurements taken. The results are listed in Table III.

### C1.2—Measurement of Resistance in the Plane that is Transverse to the Plane Formed by the Warp Threads and the Weft Threads

The fabric to be tested is cut into 40×40 mm samples so that a 4-fold stack can be made. The superimposed folds are wedged between the copper plates, the electrodes are pressed against the plates by applying a torque of 0.3 Elm on the locking screws.

We then proceed as follows:
Plug in the electrodes to measure 4 peaks with the micro-ohmmeter: one red cable, one black cable,
set the micro-ohmmeter on measurement 4Wω Auto.
Once the sample is put in place as indicated above, press on the “TRIG” button in order to determine the electrical measurement, and then read it on the screen.
For the next one, press on “TRIG” again, which determines another measurement, and so on.

3 measurements are taken per test, while restacking differently the same folds between each test.

The value of the resistance measured in the transverse plane is equal to the average of these 3 measurements. The results are listed in Table III.

### C2—Measurement of Averaue Thickness

Two types of average thickness measurement are performed:
An average thickness measurement according to the (ISO5084) standard
An average thickness measurement under reduced pressure, the protocol for which is discussed below.
   The average thickness measurement according to the ISO4084 standard is an averaged mass per unit area measurement and is taken with a pressure of 10 kPa.
   The average thickness measurement, under reduced pressure, is the result of averaged point-by-point measurements taken under reduced pressure, as below, which make it possible to verify dispersion.

The following equipment is used for the thickness measurement under reduced pressure:
Leybold Systems vacuum pump, reference number 501902
Tesa “micro-bite DCC 3D” three-dimensional machine
Tempered glass plate, thickness 8 mm
Vacuum tank ref film 818260F 205° C. Nylon 6 green from supplier Umeco, Aerovac.
Bidim AB1060HA 380 gsm 200° C. polyester non-compressed rated thickness 6 mm, supplier Umeco Aerovac.
PC with PC-Dmis V42 software
ø3 ball probe with max trigger of 0.06 N
Robuso-type cutting wheel
305×305 mm cutting template
Vacuum connector
SM5130 vacuum seal from supplier Umeco Aerovac.

The description of the measurement of thickness under reduced pressure is as follows:
Place the glass plate with the stack of three pieces of a single fabric to be tested (305×305 mm²), along with the surrounding material, in this order, from bottom to top:
   Bidim (felt known in the art)
   Stack of three pieces of a single fabric in the same direction, with the warp threads extending in the direction parallel to one edge of the 305×305mm square
   Vacuum tank.
Establish a reduced pressure of at least 15 mbars inside the vacuum tank, so as to place the stack under a pressure of 972 mbar +/−3 mbar.
A dimensional stabilization of the stack of the three pieces of fabric under reduced pressure must be reached.
Leave the stack under this reduced pressure for at least 30 minutes before taking points.
Take a physical point manually on the table (white point upper left of the table) using the joystick (“joy” on controller), validate, then change to auto mode (“auto” on controller):
Go into automatic mode and wait for the measurement to be taken.

The program takes 25 measurement points using its touch probe.

The measurement of 25 points is repeated “empty”; that is, without the stack of the three fabric pieces, in order to measure the thickness of the vacuum tank and of the glass.

Hence, by the difference in altitude measurement between, with, and without the stack, an average 25-point thickness is obtained on the stack.

The results of the thickness measurement according to the ISO5084 standard and that of measuring thickness under reduced pressure are listed in Table III.

### C3—Measurement of Transverse Permeability

Measurement of the transverse permeability of each fabric is performed according to the method described in patent application WO 2010/046609. Transverse permeability can be defined by the ability of a fluid to cross a fibrous material in the transverse direction, thus outside of the plane of the reinforcement. It is measured in m². The values in Table III are measured with the measurement equipment and techniques described in the thesis entitled “Issues in Measuring the Transverse Permeability of Fibrous Preforms for the Manufacture of Composite Structures,” by Romain Nunez, defended at the Ecole Nationale Superieure des Mines de Saint Etienne on Oct. 16, 2009; please see this publication for additional details. The variation in the FVC is obtained by successively varying the thickness of the sample.

The aim of the trials is to measure the permeability of the material tested at a given fiber volume content (FVC). The FVC is varied by successively decreasing the thickness of the sample.

Once the pressure loss is stabilized, 6 to 10 permeability measurements are performed per FVC, by recording each time the data sent by the pressure sensors and the flowmeter over a period of 60 seconds. During this period, the value of the sample thickness is measured in order to determine the current FVC content of the sample.

Between each measurement, the sample thickness is decreased and the following measurement only starts once the pressure loss is stabilized.

Measurement is performed with a check of the sample thickness during the trial by using two co-cylindrical chambers for reducing the influence of “race-tracking” (passage of the fluid next to or “on the side” of the material whose permeability is to be measured). The fluid used is water and the pressure is 1 bar +/−0.01 bar. The transverse permeability results are listed in

Table III and correspond to the average of the measurements taken.

### C4—Measurement of Air Permeability

The air permeability measurement is performed according to the EN ISO 9237 standard. These results are listed in Table III.

### C5—Measurement of Compressibility

The means used for measuring compressibility are as follows:
A mechanical universal test machine such as a ZWICK/ROELL 2300 an Instron 5582 100KN,
A Zwick furnace for taking measurements with temperature monitoring,
T-expert software (Compression Preform .ZPV),
A deformation framework,
An angular steel part for forming a deformation angle,
A plate and a press for compression,
A set of Allen keys and No. 10 flat wrenches,
A K-type thermocouple and a Kane-May KM340 display.

The compressibility measurements are taken at a temperature of 23° C. +/−3° C. and without pre-shearing.

A single sample of fabric to be tested has been placed on the corr compression plate.

The aim of the test is to compress the sample with a speed of 0.2 mm/min using a press with a diameter of 40 mm up to a fiber volume content (FVC) of 47%, with the thickness used for the measurement of this FVC being the one that is deduced based on displacement. The measurement is repeated once per sample on three different samples of a single fabric per test. We ig measure the M load corresponding to this 47% FVC. This load corresponds to the compressive stress and is expressed in newtons (N).

We draw a straight line P2 that is the tangent to point M on the load displacement curve (see FIG. 4). The slope of P2 corresponds to the compressive stiffness measurement; it is expressed in N/mm.

The higher the compressive stiffness value, the greater the processibility of the fabric.

These results are listed in Table III.

### C6—Measurement of Open Factor

The open factor (OF) was measured according to the following method:

The device is composed of a SONY (SSC-DC58AP model) camera, equipped with a 10× lens, and of a Waldmann light table, model W LP3 NR, 101381 230V 50 HZ 2×15 W. The sample to be measured is placed onto the light table, the camera is attached to a stand and positioned 29 cm away from the sample, then the sharpness is adjusted.

The measurement width is determined based on the sample to be analyzed, using the zoom, and a 10 cm ruler for open textile samples (OF>2%), 1.17 cm for samples that are not very open (OF<2%).

Using a diaphragm and a control photo, the luminosity is adjusted to obtain an OF value that corresponds to the one on the control photo.

Videomet contrast measurement software, from the Scion Image company (Scion Corporation, USA), is used. After the image is captured, it is processed as follows: using a tool, we define a maximum surface area corresponding to the selected calibration, e.g., for 10 cm-70 holes, and comprising a number of complete patterns. We then select an elementary surface area as the term is used in textiles; that is, a surface area that describes the geometry of the fabric by repetition.

With the light from the light table passing through the openings in the fabric, the OF as a percentage is defined by one hundred multiplied by the ratio between the white surface area divided by the total surface area of the elementary pattern: 100×(white surface area/elementary surface area).

It should be noted that setting the luminosity is important because diffusion phenomena may change the observed apparent size for porosity and therefore of the OF. An intermediary luminosity will be used so that no overly-great saturation or diffusion phenomenon is visible.

The results of the open factor measurements of the fabrics before needling are listed in Table I and those measured on the fabrics after needling are listed in Table III.

### C7—Measurement of Shear Stiffness

45° of Traction

The means used for measuring shear (45° of traction) are as follows:
A mechanical universal test machine such as the INSTRON 5544 50 N,
Bluehirr software,
A peel strength jaws,
Kraft paper,
A cotton canvas adhesive strip,
C97 glass glue,
A cutting template and wheel.

A test piece of the fabric to be tested is placed onto the adapted jaws, then the assembly is placed on the stand of the INSTRON (50N cell). The fabric to be tested is put in place such that the threads of the fabric are oriented at +/−45° relative to the tensioning axis.

The distance (200 mm) between the 2 jaws is measured and the displacement and cell are set at zero.

The traction speed is 20 mm/min.

We measure the load to apply based on the displacement of the jaws in order to draw the curve shown in FIG. 5. Point M is the maximum shear load (45° traction).

The straight line P2 corresponds to the tangent of the curve at the inflection point. The straight line P2 corresponds to the most pronounced slope of the measurement curve.

The slope of straight line P2 corresponds to the shear stiffness measurement; it is expressed in N/mm.

The results are listed in Table III.

### C8—Measurement of Porosity

The measurement of global porosity (Po) is obtained based on the following formula:

Po (%)=100−FVC (%)

The FVC corresponds to the fiber volume content as defined in the description (see Formula I).

The calculations obtained are listed in Table III.

### C9—Measurement of Mass per Unit Area

The mass per unit area is measured according to the ISO 3374 standard. The results are listed in Table III.

TABLE III

| | | S-2 | S-3 | S-4 | S-5 | S-7 | S-6 |
|---|---|---|---|---|---|---|---|
| Air permeability | | 4642 | 3350 | 3900 | 2534 | 3394 | <3000 |
| (in m²) | | | | | | | |
| (EN ISO 9237) | | | | | | | |
| Average | 10% | 8.661E−12 | 3.511E−12 | 8.945E−12 | 8.945E−12 | 3.642E−12 | <9E−12 |
| transverse | FVC | | | | | | |
| permeability | 20% | 1.875E−12 | 1.761E−12 | 2.667E−12 | 2.667E−12 | 1.326E−12 | <3E−12 |
| (in m²) | FVC | | | | | | |
| | 30% | 4.061E−13 | 8.833E−13 | 7.954E−13 | 7.954E−13 | 4.831E−13 | <9E−13 |
| | FVC | | | | | | |
| | 40% | 8.793E−14 | 4.430E−13 | 2.372E−13 | 2.372E−13 | 1.759E−13 | <5E−13 |
| | FVC | | | | | | |
| | 50% | 1.904E−14 | 2.222E−13 | 7.073E−14 | 7.073E−14 | 6.409E−14 | <2E−13 |
| | FVC | | | | | | |

| | | | | | | |
|---|---|---|---|---|---|---|
| Transverse electrical | 0.237 | 0.361 | 0.239 | 0.412 | 0.283 | <0.4 |
| resistance (in Ohms) | | | | | | |
| Surface resistance | 5.955 | 3.934 | 5.167 | 3.812 | 4.608 | <4 |
| (in Ohms) | | | | | | |
| Compressive stiffness | 1579 | 1552 | 1518 | 1520 | 1571 | >1500 |
| (in N/mm) | | | | | | |
| Compressive stress | 293 | 244 | 323 | 230 | 247 | <300 |
| (Load for an FVC of 47%) | | | | | | |
| (in N) | | | | | | |
| Maximum shear load | 11.65 | 13.17 | 30.75 | 12.79 | 13.11 | >10 |
| (45° traction) (in N) | | | | | | |
| Shear stiffness (in N/mm) | 0.237 | 0.361 | 0.239 | 0.412 | 0.283 | >0.35 |
| (45° traction) | | | | | | |
| Thickness measurement | 0.125 | 0.098 | 0.115 | 0.105 | 0.104 | <0.1 |
| under vacuum (in mm/fold) | | | | | | |
| Thickness measurement | 0.376 | 0.282 | 0.388 | 0.304 | 0.312 | <0.3 |
| according to ISO5084 | | | | | | |
| standard (in mm) | | | | | | |
| Mass per unit area | 68.168 | 75.066 | 74.162 | 71.538 | 73.942 | <75 |
| (in g/m²) (ISO 3374) | | | | | | |
| Porosity (in %) calculated | 89.87 | 85.13 | 89.32 | 86.85 | 86.76 | <87 |
| based on thickness | (FVC = | (FVC = | (FVC = | FVC = | (FVC = | (FVC > 13%) |
| measurements taken | 10.13%) | 14.87%) | 10.68%) | 13.15%) | 13.24%) | |
| according to ISO5084 | | | | | | |
| standard and on mass per | | | | | | |
| unit area measurements | | | | | | |
| Open factor (OF) of fabric | 16.9 | 13.8 | 11.4 | 12.7 | 11.2 | 6.4 |
| after needling (in %) | | | | | | |

### D—Diffusion Layer Production

To obtain a diffusion layer (or GDL), a first step consists of treating the needled (or non-needled) fabric with a liquid composition that forms a hydrophobic coating, followed by heat treatment under air at 350° C. A second step consists of treating the fabric that has a hydrophobic coating with a liquid composition that forms a microporous layer, followed by a heat treatment at 350° C. for 2 hours.

### D1—Liquid Compositions for Forming a Hydrophobic Coating

Table IV lists the various formulations of the liquid compositions (CRH) used to form the hydrophobic coating (HC) in the diffusion layers.

TABLE IV

| | CRH-1 | CRH-2 |
|---|---|---|
| Hydrophobic agent | 1.2% | 9.23% |
| (PTFE) | | |
| Carbon nanofibers | 2.4% | 0% |
| VGCF-H | | |
| Dispersing agent | 0.5% | 0% |
| (Triton X100) | | |
| Qsp water | 95.9% | 90.77% |

The percentages are percentages by weight expressed relative to the total weight of the liquid composition.

The liquid compositions CRH-1 and CRH-2 are obtained by mixing the products and homogenizing the suspension using a Dispermat. This apparatus rotates a serrated wheel at 2000 rpm inside the liquid composition to create a vortex phenomenon while applying a vacuum (P=−0.9 bar) for 20 min. This step breaks up any clumps that are present and eliminates gas that may be trapped inside the liquid composition.

Using the liquid compositions CRH-1 and CRH-2 produces the following hydrophobic coatings, listed in Table V:

TABLE V

| | CRH-1 | CRH-2 |
|---|---|---|
| Hydrophobic agent | 23.2% | 100% |
| Carbon nanofibers | 76.8% | 0% |

The percentages are percentages by weight expressed relative to the total weight of the dry hydrophobic coating.

### D2—Liquid Composition for Forming a Microporous Layer

When a microporous layer was applied, the liquid composition used for the formation of this microporous layer had the following composition (CL-MPL):
2.67% of hydrophobic agent (PTFE)
4.35% of carbon nanofibers (VGCF-H from Rhodia)
0.99% of viscosifier (methylcellulose)
1.5% of dispersing agent (Triton X100)
3.17% of carbon black
87.32% of water (QSP)

This liquid composition is obtained by mixing the products and homogenizing the suspension using a Dispermat, as described above for the liquid composition used to deposit the hydrophobic coating.

The percentages are percentages by weight expressed relative to the total weight of the liquid composition.

Using this liquid composition produces the following microporous layer:
11.54% of hydrophobic agent (PTFE)
51.12% of carbon nanofibers (VGCF-H from Rhodia)
37.34% of carbon black

The percentages are percentages by weight expressed relative to the total weight of the microporous layer ultimately obtained, after heat treatment.

### D3—Examples of Diffusion Layers

The diffusion layers GDL-2 to GLD-11 are obtained according to the operating conditions presented below. Table VI lists, for each diffusion layer, the needled (or non-needled) fabric that is used as a support, the hydrophobic coating, and the microporous layer used.

First, the supports S-1 to 5-10 are treated so that they will have a hydrophobic coating. To do this, the supports are submerged in a bath of the selected CRH liquid composition using an impregnator. Next, the supports undergo heat treatment at 350° C. under air.

The liquid composition CL-MPL is then deposited via a coating method onto the previously obtained support that has a hydrophobic coating. After the composition is spread onto said support, the latter is dried directly on the coating bench at 80° C. in order to solidify the microporous layer. Next, a heat treatment at 350° C. under air is performed. Lastly, 2.5 mg/m² of microporous layer is obtained.

TABLE VI

| | | | | Microporous layer |
|---|---|---|---|---|
| Diffusion | Support | Hydrophobic coating and | | and its percentage |
| layer no. | no. | its percentage by weight ^{c} | | by weight ^{c} |
| GDL-1 | SN-T | | | |
| GDL-2 | S-2 | CRH-1 | 75.5% | 33.3% |
| GDL-3 | S-3 | CRH-1 | 75.5% | 33.3% |
| GDL-4 | S-4 | CRH-1 | 75.5% | 33.3% |
| GDL-5 | S-5 | CRH-1 | 75.5% | 33.3% |
| GDL-6 | S-6 | CRH-2 | 75.5% | 33.3% |
| GDL-7 | S-7 | CRH-1 | 75.5% | 33.3% |
| GDL-8 | S-1 | CRH-3 | 11.1% | 25.5% |
| GDL-9 | S-6 | CRH-4 | 75.5% | 33.3% |
| GDL-10 | S-8 | CRH-5 | 75.4% | 25.5% |
| GDL-11 | S-9 | CRH-3 | 10% | 20% |

^{c}the percentages by weight are given relative to the total mass of the fabric prior to treatment.

### E—Measurement of Current Density

### E1—Membrane Electrode Assembly (MEA)

The diffusion layers GDL-1 to GDL-11 are then used in a membrane electrode assembly (MEA).

To validate their performance under operating conditions, the diffusion layers GDL-1 to GDL-11 are assembled with three layers (membrane corresponding to the diffusion layer, anode, and cathode) in a 25 cm² monocell. The electrodes are composed of catalyst and of a Nafion-type ionomer. This monocell is then conditioned and evaluated on a test bench enabling precise control of operating conditions:
Pressure
Temperature
Stoichiometry
Humidity

Following 12 hours of conditioning, the performance of the GDLs is evaluated under three main conditions:
automobile condition 80° C. 50% RH 1.5 Bar
humid condition (automobile startup) 60° C. 100% RH 1.5 Bar
drying condition 80° C. 20% RH 1.5 Bar.

These three conditions make it possible to validate the GDLs within a broad operating spectrum.

### E2—Measurement of Current Density

The performance of the membrane electrode assembly (MEA) is determined by a polarization curve.

The polarization curve of a membrane electrode assembly (MEA) indicates the change in voltage based on the current density passing through the monocell. Therefore, it makes it possible to evaluate the electrochemical performance of this monocell.

It is recorded in each operating condition, following stabilization of the various parameters (example, pressure, temperature, relative humidity (RH), etc.) for at least one hour, under a current density (I_{stabilization}=10 A except for the initial automobile condition, for which I_{stabiltization}=25 A).

The scanning speed is Vb=1 A/min over the entire polarization curve; it is carried out in the increasing direction of the current density.

The change in the current is stopped during data acquisition if the voltage drops below 420 mV or upon reaching the Imax current=37.5 A.

### E3—Results

### E3.1—Effect of the Support on the Properties of the MEA

FIG. 6 shows the MEA polarization curves including a diffusion layer according to the invention (GDL-2, GDL-3, GDL-4, GDL-5 and GDL-7) and a polarization curve of an MEA including a diffusion layer not covered by the invention (GDL-1).

The performance of the diffusion layers according to the invention is as high as that of the commercial GDL-1 diffusion layer. The GDL-4 diffusion layer's performance is slightly better than that of the commercial GDL-1 diffusion layer.

FIGS. 7A, 7B, 7C show the MEA polarization curves including a diffusion layer according to the invention (GDL-6) and a polarization curve of an MEA including a diffusion layer not covered by the invention (GDL-1), for conditionings at different temperatures and humidity levels. (FIG. 7A: conditioning 80° C., 50% RH (automobile), FIG. 7B: conditioning 60° C., 100% RH and FIG. 7C: conditioning 80° C., 20% RH). Regardless of the conditioning, the diffusion layers according to the invention offer electrochemical performance levels similar to that of the diffusion layer not covered by the invention, which corresponds to the best available commercial reference.

FIG. 8 shows the MEA polarization curves including a diffusion layer according to the invention (GDL-5) and a diffusion layer according to the invention for which needling conditions have been optimized (GDL-6). These curves show that it is possible to improve the electrochemical performance of a diffusion layer by adapting needling conditions to the woven support being used.

### E3.2—Illustration of Various Compositions of the Hydrophobic Coating on the Properties of an MEA Including a Diffusion layer According to the Invention

FIG. 9 shows the polarization curves of an MEA including a diffusion layer (GDL-10) according to the invention for which the composition of the hydrophobic coating varies relative to GDL-6, and a polarization curve of an MEA including a diffusion layer not covered by the invention (GDL-1).

These results show that the mass ratios of the hydrophobic agent, the carbon nanofibers, and the dispersing agent in the hydrophobic coating of a diffusion layer make it possible to optimize its performance, but that the variations contributed relative to GDL-6 again make it possible to obtain better performance relative to GDL-1.

### E3.3—Effect of Needling on the Properties of the MEA Including a Diffusion Layer

FIG. 10 shows the polarization curves of an MEA including a diffusion layer according to the invention (GDL-9) and a diffusion layer not covered by the invention (GDL-8) that uses the same fabric but is not needled. It appears that needling greatly improves performance.

### E3.4—Effect of the Nature of the Support on the Properties of the MEA Including a Diffusion Layer

FIG. 11 shows the polarization curves of an MEA including a diffusion layer according to the invention (GDL-6) and a diffusion layer not covered by the invention (GSL-11, needled unidirectional sheet). Here again, selecting the fabric according to the invention greatly improves performance.

### F—Conclusion

These results demonstrate that using a needled fabric as set forth in the framework of the invention improves the performance of the support used in a GSL and makes it possible to obtain performance that is similar to or even better than the commercial product S-NT (Signacet BC). The composition and quantity of the hydrophobic coating have also been optimized in relation with the selected support. The supports according to the invention offer especially satisfactory processibility and handling properties.

1. A diffusion layer for a fuel cell comprising at least one needled fabric comprising at least one hydrophobic coating, said needled fabric being made from a fabric including carbon threads and having a mass per unit area of 40 g/m² to 80 g/m², said fabric having a thickness and haying been needled to provide said needled fabric that comprises staple fibers, said staple fibers extending out from the carbon threads of the needled fabric from which they originate and extending in a direction that is not parallel to the direction of the carbon thread from which they originate.

2. The diffusion layer according to claim 1, wherein at least a portion of the staple fibers extend along the thickness of the needled fabric.

3. (canceled)

4. The diffusion layer according to claim 1, wherein said needled fabric comprises needling impacts and wherein the density of needling impacts falls within the range of 50 to 650 needling impacts/cm² per side, the needling impacts being located on only one side of the needled fabric or on both sides of the needled fabric.

5. The diffusion layer according to claim 1 wherein the needled fabric is composed of warp threads and of weft threads, the staple fibers originating from the warp threads and/or from the welt threads.

6. (canceled)

7. (canceled)

8. The diffusion layer according to claim 1, wherein the carbon threads are selected from high-resistance carbon threads, high-module carbon threads, and intermediate module carbon threads.

9. (canceled)

10. (canceled)

11. (canceled)

12. (canceled)

13. (canceled)

14. (canceled)

15. (canceled)

16. (canceled)

17. The diffusion layer according to claim 1, wherein the hydrophobic coating includes at least one hydrophobic agent selected from tetrafluoroethylene and fluorinated ethylene propylene.

18. The diffusion layer according to claim 1, wherein the hydrophobic coating additionally includes carbon nanofibers.

19. (canceled)

20. (canceled

21. (canceled)

22. The diffusion layer according to claim 1, wherein the diffusion layer additionally includes at least one microporous layer that comprises pores.

23. The diffusion layer according to claim 22, wherein the diameter of the pores of said microporous layer ranges from 0.01 to 10 μm.

24. The diffusion layer according to claim 22, wherein the microporous layer includes carbon black and at least one hydrophobic agent, selected from tetrafluoroethylene and fluorinated ethylene propylene.

25. The diffusion layer according to claim 22, wherein the microporous layer additionally includes carbon nanofibers.

26. (canceled)

27. Method for making a diffusion layer for a fuel cell, said method comprising the steps of:
providing at least one fabric including carbon threads, said fabric having a mass per unit area within the range of 40 g/m² to 80 g/m²;
needling said fabric from one of its broad sides to form a needled fabric which comprises needling impacts; and
forming a hydrophobic coating on said needled fabric.

28. The method according to claim 27, wherein said fabric has an open factor within the range of 0 to 5%.

29. (canceled)

30. (canceled)

31. (canceled)

32. The method according to claim 27, wherein the density of said needling impacts is within the range of 50 to 650 needling impacts/cm² per side, the needling impacts being located on only one side of the needled fabric or on both sides of the needled fabric.

33. (canceled)

34. The method according to claim 27, wherein a liquid composition is used to form the hydrophobic coating, said liquid composition comprising at least one hydrophobic agent, selected from tetrafluoroethylene and fluorinated ethylene propylene.

35. The method according to claim 34, wherein the liquid composition additionally includes a dispersing agent, carbon nanofibers, and at least one solvent such as water, ethanol, propanol, ethylene glycol, and mixtures thereof.

36. (canceled)

37. (canceled)

38. The method according to claim 27, which includes the additional step of forming a microporous layer on one or both broad sides of said diffusion layer.

39. The method according to claim 38, wherein a liquid composition is used to form said microporous layer and wherein said liquid composition includes carbon black and at least one hydrophobic agent selected from tetrafluoroethylene and fluorinated ethylene propylene.

40. The method according to claim 39, wherein said liquid composition for forming said microporous layer additionally includes a viscosifier, at least one dispersing agent, and carbon nanofibers.

41. (canceled)

42. A fuel cell which comprises a diffusion layer according to claim 1.

43. (canceled)

44. A fuel cell which comprises a diffusion layer according to claim 22.
